(19) United States
(12) Patent Application Publication
(10) Pub. No.: US 2024/0380453 A1
(43) Pub. Date: Nov. 14, 2024

(54) UE REPORTING OF SUITABLE SRS CONFIGURATION

(71) Applicant: QUALCOMM Incorporated, San Diego, CA (US)

(72) Inventors: Ruiming ZHENG, Beijing (CN); Muhammad Sayed Khairy ABDELGHAFFAR, San Jose, CA (US); Yu ZHANG, San Diego, CA (US); Alexandros MANOLAKOS, Athens (GR); Runxin WANG, San Diego, CA (US)

(21) Appl. No.: 18/683,503

(22) PCT Filed: Oct. 14, 2021
(86) PCT No.: PCT/CN2021/123735

§ 371 Date: Feb. 13, 2024

(51) Int. Cl. H04B 7/06; H04L 1/1607; H04W 76/38

(52) U.S. Cl. CPC H04B 7/0602; H04L 1/1614; H04W 76/38

(57) ABSTRACT

A user equipment (UE) may identify at least one suitable configuration for sounding reference signal (SRS) antenna switching and transmit the at least one suitable configuration for SRS antenna switching to the base station via a medium access control (MAC) control element (CE) (MAC-CE) or a radio resource control (RRC) message. The base station may receive the at least one suitable configuration for SRS antenna switching from the UE, and transmit an active SRS antenna switching configuration to the UE, the active SRS antenna switching configuration based on the suitable configuration for SRS antenna switching received from the UE.

### TECHNICAL FIELD

The present disclosure relates generally to communication systems, and more particularly, to a method of wireless communication including a UE reporting a configuration for sounding reference signal (SRS) antenna switching.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE) and a base station. The UE may identify at least one suitable configuration for sounding reference signal (SRS) antenna switching, and transmit the at least one suitable configuration for SRS antenna switching to the base station via a medium access control (MAC) control element (CE) (MAC-CE) or a radio resource control (RRC) message. The base station may receive the at least one suitable configuration for SRS antenna switching from the UE, and transmit an active SRS antenna switching configuration to the UE, the active SRS antenna switching configuration based on the suitable configuration for SRS antenna switching received from the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A, 4B, and 4C are examples of medium access control (MAC) control element (CE) (MAC-CE) of wireless communication.

FIG. 5 is a call-flow diagram of a method of wireless communication.

FIG. 6 is a flowchart of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a diagram illustrating an example of a hardware implementation for an example apparatus.

FIG. 11 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

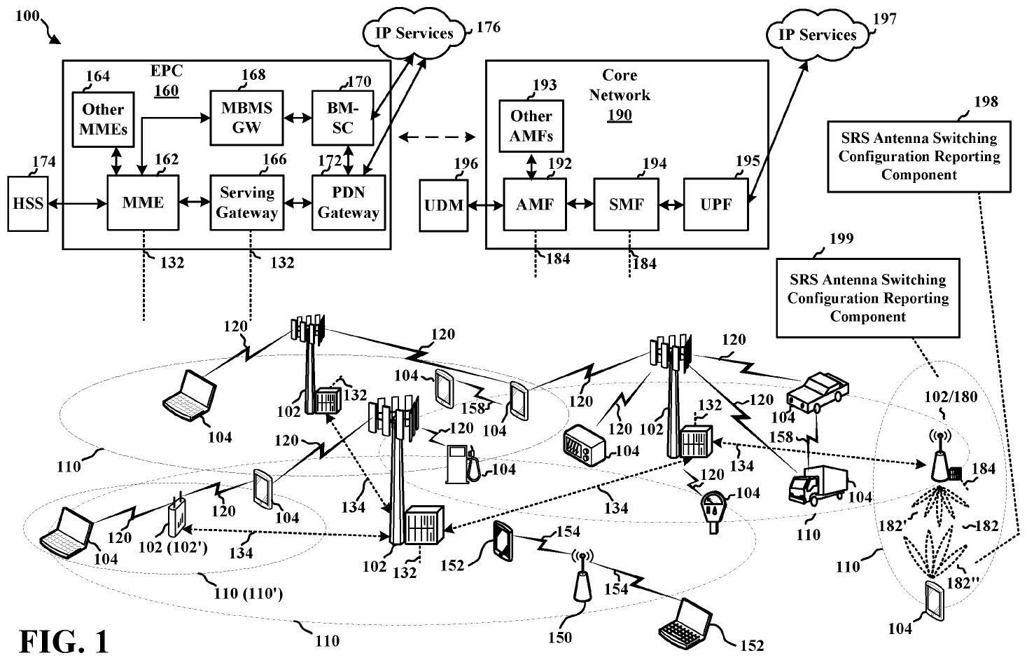

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SRS antenna switching configuration reporting component 198 configured to identify at least one suitable configuration for SRS antenna switching, transmit, to a base station, an indication of the at least one suitable configuration for the SRS antenna switching, and receive, from the base station, an indication of an active configuration for the SRS antenna switching based at least in part on the at least one suitable configuration. In certain aspects, the base station 180 may include an SRS antenna switching configuration reporting component 199 configured to receive, from a UE, an indication of at least one suitable configuration for SRS antenna switching, select an active configuration for the SRS antenna switching based at least in part on the at least one suitable configuration for the SRS antenna switching, and transmit, to the UE, an indication of the active configuration for the SRS antenna switching. Although the following description may be focused on 5G NR, the concepts described herein may be applicable to other similar areas, such as LTE, LTE-A, CDMA, GSM, and other wireless technologies.

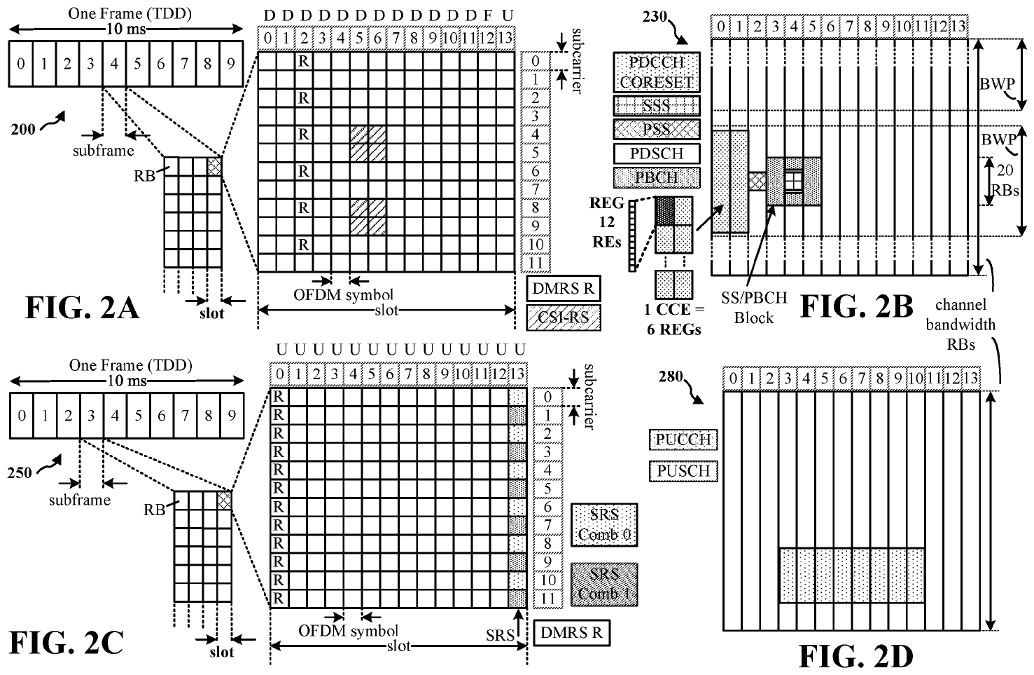

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

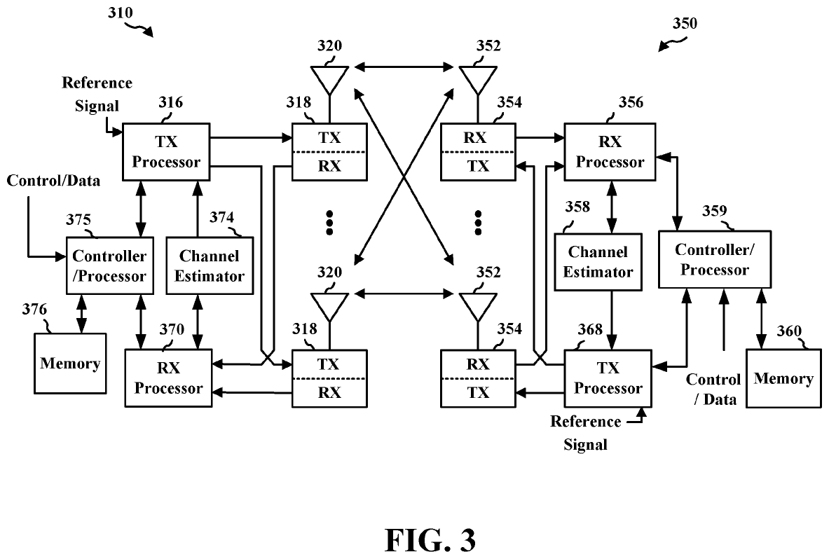

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 199 of FIG. 1.

In some aspects, a UE may be configured with a UE capability indicating at least one of a combination of sounding reference signal (SRS) antenna switching configurations (e.g., 2 transmit (Tx) ports and 4 receive (Rx) ports (2T4R), 1 Tx port and 4 Rx ports (1T4R), or 1 Tx port and 2 Rx ports (1T2R)) supported by the UE, and a network including a base station may configure multiple BWPs with different SRS antenna configurations, among at least one combination of SRS antenna switching configurations supported by the UE. Here, the base station may configure the UE with the SRS for antenna switching, and the configuration may indicate a number of transmit (Tx) ports and a number of receive (Rx) ports. As indicated above, 2T4R may refer to two Tx ports and four Rx ports, 1T4R may refer to one Tx port and four Rx ports, and 1T2R may refer to one Tx port and two Rx ports. The base station may configure a set of SRS antenna switching configurations and activate or deactivate at least one SRS antenna switching configuration among the set of SRS antenna switching configurations.

The UE may transmit SRS for the antenna switching based on the SRS antenna switching configuration. The base station may receive the SRS for antenna switching from the UE and determine the antenna port configuration of the UE for Tx and Rx transmissions. For example, a narrowband BWP may be configured with a downgraded configuration 1T2R, while a wideband BWP could be configured with 2T4R. That is, the base station may initially configure the UE operating on the wideband BWP with 2T4R, and based on determining that the UE is operating on the narrowband BWP, the base station may downgrade the configuration to 1T2R. A mechanism to adapt or change the SRS configuration within the BWP may be introduced.

The base station may determine the active configuration for the SRS antenna switching based at least in part on at least one of the at least one suitable configuration for the SRS antenna switching, the base station's condition, or the network condition. Here, the base station's condition may include the base station's power consumption, expected traffic in the UL/DL transmissions at the base station, available network resources, etc. In one aspect, the base station may be configured to select one or more suitable SRS antenna switching configuration as the active configuration for the SRS antenna switching. In another aspect, the base station may determine that the at least one suitable SRS antenna switching configuration is not acceptable, and the active configuration for the SRS antenna switching may not be selected among the at least one suitable configuration for SRS antenna switching.

In some aspects, the UE may be configured with the SRS antenna switching for six (6) Rx ports/antennas or eight (8) Rx ports/antennas. That is, the UE may be configured with xTyR (i.e., x Tx ports and y Rx ports), where x=1, 2, or 4 and y=6 or 8. In one example, some switching configuration (e.g., 1T8R), multiple numbers of SRS resources may be configured. For example, the UE may be configured with 1T8R, and eight SRS resources may be configured to accommodate the eight Rx ports. The increased number of slots may not be configured within one slot, and accordingly, multiple SRS resource sets may be configured for the multiple numbers of SRS resources. For example, the UE may be configured with four (4) sets with two (2) SRS resources per set, and each set may be allocated in a slot. Also, the UE may be configured to multiplex the SRS with different UL signals/channels.

In some aspects, the network may configure the UE not to sound or configure all SRS resources based on channel conditions. That is, the network may consider the channel conditions and configure the number of the antenna ports of the UE to transmit the SRS. For example, when some of the antenna ports may experience bad or poor channel conditions, the network may limit the maximum MIMO to a smaller number, and accordingly, the base station may reduce the number of Tx or Rx ports of the UE for the SRS.

In some aspects, the base station and the UE may change the SRS antenna switching configuration to conserve power or network resources. In one aspect, the UE may decide to turn off or deactivate at least one antenna for power-saving purposes, and the UE may not need to sound or configure the deactivate antenna. In another aspect, the network may introduce a mechanism to allow or instruct the UE to adapt (downgrade or upgrade) the SRS antenna switching within the operating BWP to save or conserve some network resources or the UE power consumption.

In some aspects, a MAC-CE command that may include a bitmap to indicate which SRS resources within the SRS resource set may be activated or deactivated. That is, the base station may initially setup the SRS resource set including a plurality of SRS resources that may be activated or deactivated, and transmit the MAC-CE message that may activate or deactivate one or more SRS resources within the SRS resource set. The MAC-CE may include the bitmap indicating which of the one or more SRS resources within the SRS resource set may be activated or deactivated. The MAC-CE may include the N-bit field, where N is the number of SRS resources in the set, controls which of the SRS resources of the set are switched ON and OFF. That is, the base station may transmit the MAC-CE including the N-bit field, each bit of the N-bit field corresponding to the SRS resource set, and each value of the N-bit field may represent whether the corresponding SRS resource is activated or deactivated. For example, if an aperiodic SRS resource set with 4 SRS resources can be triggered with codepoint ‘01’ and ‘10’, then the MAC CE command may indicate that for codepoint ‘01’, resources 0 and 2 are switched ON, whereas for codepoint ‘10’, resources 1 and 3 are switched ON. Such a mechanism may be specified for a specific use-case like antenna-switching, based on an SRS resource set having more than 4 SRS resources. In some aspects, a physical layer (L1) signaling or a data link layer (L2) signaling including rules for SRS resource (set) activation and deactivation as well as SRS port mapping may be provided. That is, the base station may transmit, to the UE, the L1 signaling or the L2 signaling indicating the activation or deactivation of one or more SRS resources (or SRS resource sets) and/or the SRS port mapping.

In addition to the network configuring activation and deactivation of the SRS resource (set) via the L1/L2 signaling, the UE may indicate, to the network, its suitable (i.e., recommended or desirable) SRS antenna switching configuration, (e.g., xTyR), so that the network may be able to configure the appropriate SRS resources configuration. That is, the UE may identify at least one suitable SRS antenna switching configuration based on the UE and network conditions, and transmit the at least one suitable SRS antenna switching configuration to the network. The network may consider the at least one suitable SRS antenna switching configuration received from the base station to determine an active configuration of the SRS antenna switching. The suitable SRS antenna switching configuration may be transmitted to the base station via a MAC-CE or an RRC message, where the RRC message may include UE assistance information or a dedicated RRC message.

The base station may be configured to indicate the activation or deactivation of one or more SRS resources (or SRS resource set) and/or the SRS port mapping for an aperiodic SRS, a periodic SRS, or a semi-persistent SRS. The UE may be configured to report at least one suitable antenna switching configuration.

The active antenna switching configuration indicated by the base station, or the suitable antenna switching configuration reported by the UE, may be identified or selected among the antenna switching configuration supported by the UE as reported in the UE capability signaling. That is, the UE may report, to the base station, the antenna switching configuration supported by the UE via the RRC message including the UE capability signaling, and the UE may identify the suitable antenna switching configuration from the antenna switching configuration supported by the UE and the base station may select the active antenna switching configuration from the antenna switching configuration supported by the UE.

In one aspect, the DCI may be additionally used to indicate to activate or deactivate antenna switching configuration. A change on the configured number of Tx antennas in each SRS resource may be specified in either the base station indication or the UE reporting.

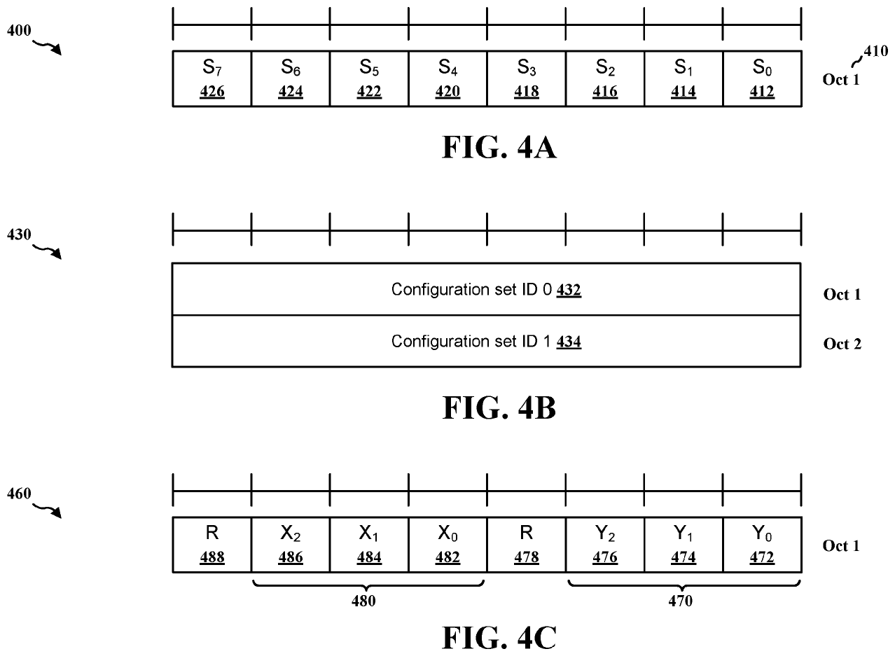

FIGS. 4A, 4B, and 4C are examples of MAC-CE 400, 430, and 460 for wireless communication. The MAC-CEs 400, 430, and 460 may illustrate different formats of the MAC-CE that a UE may use to report the suitable SRS antenna switching configuration to the base station.

The base station first may transmit, to the UE, one or more pre-configurations of candidate SRS antenna switching via the RRC message. The one or more pre-configurations of the candidate SRS antenna switching may indicate the SRS antenna switching configuration of xTyR, indicating x number of Tx ports and y number of Rx ports. For example, the one or more pre-configurations of the candidate SRS antenna switching may include 1T2R, 1T4R, 1T8R, 2T4R, etc. The RRC message of the pre-configuration may be transmitted via system information in the RRC signaling or a dedicated RRC signaling. The base station may determine the pre-configurations based on the UE capability. Furthermore, the base station may transmit the RRC message to reconfigure or de-configure the list of the candidate SRS antenna switching configuration by dedicated RRC signaling. The RRC message may add or remove the element from at least one of the SRS antenna switching configurations. In one aspect, the initial RRC configuration list may be based on the UE capability reporting of combined SRS antenna switching. That is, the UE base station may determine the pre-configurations of candidate SRS antenna switching based on the antenna switching configuration supported by the UE as reported in the UE capability signaling. In another aspect, the initial RRC configuration list may be based on a configuration supported by the UE, and the initial RRC configuration list may include the fallback (or downgrade configuration) or subset configurations of the configuration supported by the UE. For example, when the UE supports one configuration of 1T8R, the base station may configure the initial list to include 1T6R, 1T4R, or 1T2R.

Based on the list of candidate SRS antenna switching configurations configured for the UE, the UE may need to change the SRS resource configuration, and the UE may send, to the base station, a MAC-CE to indicate the suitable SRS antenna switching configuration. The UE may indicate one or more suitable SRS antenna switching configurations via a MAC-CE. Various formats of the MAC-CE may be configured for the UE to indicate the suitable SRS antenna switching configuration to the base station.

FIG. 4A depicts a first MAC-CE 400 illustrating an example of the first format of the MAC-CE 400 of the UE to report the suitable SRS antenna switching configuration to the base station. The MAC-CE 400 may include a bitmap solution with each bit representing the index of the SRS antenna switching configuration in the pre-configuration including the list of the candidate SRS antenna switching configurations. For example, the first octet 410 of the MAC-CE 400 may include 8 bits including a first bit 412, a second bit 414, a third bit 416, a fourth bit 418, a fifth bit 420, a sixth bit 422, a seventh bit 424, and an eighth bit 426, and each bit of the eight bits may represent different candidate SRS antenna switching configurations. For example, the list of the candidate SRS antenna switching configuration may be pre-configured by the base station as provided in the below table, with the corresponding index numbers.

| | | | | | | | | |
|---|---|---|---|---|---|---|---|---|
| Index | 0 | 1 | 2 | 3 | 4 | 5 | 6 | 7 |

| | | | | | | | |
|---|---|---|---|---|---|---|---|
| configuration | 1T4R | 1T6R | 2T4R | 2T6R | 4T4R | 4T6R | reserved |

The UE may determine that the SRS antenna switching configurations of 2T4R and 2T6R are suitable based on at least one of the UE's condition or the network condition. Here, the UE's condition may include the UE's power consumption, expected traffic in the UL/DL transmissions, UE RRC states, etc., and the network condition may include the channel condition, BWP, etc. The UE may generate the eight bits of the first octet 410 to be ‘00001100’, indicating that the third bit 416 and the fourth bit 418 have the value 1. The base station may receive the MAC-CE, and understand that the UE indicated that the SRS antenna switching configurations of the 2T4R and 2T6R are suitable, and take into consideration the suitable SRS antenna switching configurations when determining the active SRS antenna switching configuration for the UE.

FIG. 4B depicts a second MAC-CE 430 illustrating an example of the second format of the MAC-CE 430 of the UE to report the suitable SRS antenna switching configuration to the base station. The MAC-CE 430 may include an explicit configuration ID that indicates the suitable SRS antenna switching configuration. In one aspect, the MAC-CE 430 may include a first octet 432 and a second octet 434. The first octet 432 and the second octet 434 may carry ID of the corresponding SRS antenna switching configurations. For example, the UE may determine that the 2T4R and 4T4R are suitable based on at least one of the UE's condition or the network condition, with a first configuration ID of ‘00000010’ indicating the 2T4R configuration and a second configuration ID of ‘00000100’ indicating the 4T4R configuration. The first octet 432 may have the value of ‘00000010’ corresponding to the 2T4R configuration, and the second octet 434 may have the value of ‘00000100’ corresponding to the 4T4R configuration.

In another aspect, one octet may carry a configuration set ID indicating a set of SRS antenna switching configurations that are suitable SRS antenna switching configurations. For example, the first octet 432 may carry a configuration set ID indicating a set of suitable SRS antenna switching configurations. The UE may determine that the 2T4R and 4T4R are suitable based on at least one of the UE's condition or the network condition, and a configuration set ID ‘10000100’ may be specified in a table or a database to indicate an SRS configuration set of 2T4R and 4T4R. The base station may receive the MAC-CE including the first octet 432 having the value of ‘10000100’, and from the table or the database to understand that the suitable SRS antenna configuration.

FIG. 4C depicts a third MAC-CE 460 illustrating an example of the third format of the MAC-CE 460 of the UE to report the suitable SRS antenna switching configuration to the base station. The MAC-CE 460 may directly specify the suitable SRS antenna switching configuration. That is, the MAC-CE 460 may specify a number of Rx ports and a number of Tx ports of the suitable SRS antenna switching configuration. For example, the MAC-CE 460 may include a first octet including a first set of three bits 470 including a first bit 472, a second bit 474, and a third bit 476, a second set of three bits 480 including a fifth bit 482, a sixth bit 484, and a seventh bit 486, and two reserved bits including a fourth bit 478 and an eighth bit 488. The first set of three bits 470 may specify the number of Rx ports of the suitable SRS antenna switching configuration, and the second set of three bits 480 may specify the number of Tx ports of the suitable SRS antenna switching configuration. For example, the UE may determine that the SRS antenna switching configuration of 2T4R is suitable based on at least one of the UE's condition or the network condition. Accordingly, the UE may transmit the MAC-CE 460 including the first octet having the value of ‘00010010’, including the first set of three bits 470 having the value of ‘010’ indicating the four (4) Rx ports and the second set of three bits 480 having the value of ‘001’ indicating the two (2) Tx ports of the SRS antenna switching configuration of 2T4R.

Based on the third example of MAC-CE 460, the UE may transmit the suitable SRS antenna switching configuration without a reference to a pre-configured list of SRS antenna switching configurations in the RRC message. The UE may also indicate one or multiple suitable SRS antenna switching configurations via a MAC-CE. That is, the UE may include a second octet to indicate a second suitable SRS antenna switching configuration. The base station may receive the MAC-CE 460, and the base station may select one active SRS antenna switching configuration based on at least a part in the MAC-CE 460 and configure the active SRS antenna switching configuration to the UE.

The base station may configure a prohibit timer for the UE, and the UE may transmit the MAC-CE based on the prohibit timer. That is, the UE may start the prohibit timer in response to reporting the suitable SRS antenna switching configuration in the MAC-CE, while the UE may prohibit from reporting the suitable SRS antenna switching configuration to the base station while the prohibit timer is running. That is, the UE may transmit the MAC-CE indicating the suitable SRS antenna switching configuration when the prohibit timer is not running or expired. The prohibit timer may be configured by an RRC message. That is, the base station may transmit the RRC message indicating the prohibit timer to the UE.

In some aspects, the UE may transmit the suitable antenna switching configuration using an RRC message. In one aspect, the UE may determine to indicate the suitable SRS antenna switching configuration, and the UE may include the suitable antenna switching configuration as a dedicated parameter or an information element (IE), e.g., Suitable_SRS_Antenna_Switching, in an RRC message transmitted to the base station, e.g., UEAssistanceInformation. That is, the UE may have the suitable SRS antenna switching configuration based on at least one of the UE's condition or the network condition, and the UE may include the dedicated parameter or the IE, e.g., Suitable_SRS_Antenna_Switching, indicating the suitable antenna switching configuration in the RRC message, e.g., UEAssistanceInformation, and transmit the RRC message including the suitable SRS antenna switching configuration to the base station. For the dedicated example, parameter or the IE, e.g., Suitable_SRS_Antenna_Switching, may include the values indicating an enumerated list of suitable SRS antenna switching configuration from the candidate SRS antenna switching configuration list, e.g., {1T2R, IT4R, IT8R, 2T4R, etc.}.

The base station may configure a prohibit timer for the UE, and the UE may transmit the RRC message based on the prohibit timer. That is, the UE may start the prohibit timer in response to reporting the suitable SRS antenna switching configuration, while the UE may prohibit from reporting the suitable SRS antenna switching configuration to the base station while the prohibit timer is running. That is, the UE may indicate the parameter or IE indicating the suitable SRS antenna switching configuration in the RRC message when the prohibit timer is not running or expired. The prohibit timer may be configured by an RRC message. That is, the base station may transmit the RRC message indicating the prohibit timer to the UE.

Furthermore, the UE may be configured to report the suitable SRS antenna switching configuration in response to the suitable SRS antenna switching configuration is different from the previously transmitted suitable SRS antenna switching configuration. For example, the UE may determine that the value of the current parameter or IE, e.g., Suitable_SRS_Antenna_Switching, is different from the one indicated in the last transmission of the RRC message, e.g., UEAssistanceInformation, and the UE may not transmit a new RRC message, e.g., UEAssistanceInformation, message including the current parameter or IE, e.g., Suitable_SRS_Antenna_Switching, based on the current parameter or IE being same as the one indicated in the last transmission of the RRC message.

In another aspect, the UE may transmit the suitable SRS antenna switching configuration via a dedicated UL RRC message. That is, the base station may configure the UE with the dedicated RRC message to transmit the suitable SRS antenna switching configuration to the base station.

In one aspect, the network may send a request of the RRC message including the suitable SRS antenna switching configuration, and the UE may report the RRC message including the suitable SRS antenna switching configuration in the UL transmission. The content of the dedicated RRC message of the SRS antenna switching configuration may be substantially the same as the parameter or the IE, e.g., Suitable_SRS_Antenna_Switching, indicating the suitable antenna switching configuration in the RRC message, e.g., UEAssistanceInformation.

In some aspects, the UE may be configured to report the suitable SRS antenna switching configuration to the base station in response to meeting at least one condition. That is, the UE may determine whether at least one condition is met, and based on determining that the at least one condition is being met, may report the suitable SRS antenna switching configuration to the base station.

In one aspect, the UE may be configured to report the parameter or the IE, e.g., Suitable_SRS_Antenna_Switching, indicating the suitable antenna switching configuration in an RRC message to the base station when at least one options or condition is met. In another aspect, the UE may be configured to report the MAC-CE indicating the suitable antenna switching configuration to the base station when at least one option or condition is met.

In one example, the at least one condition or option may include the suitable SRS antenna switching configuration indicated in the last transmission. That is, the UE may compare the identified SRS antenna switching configuration to the last transmitted suitable SRS antenna switching configuration, and may determine to transmit the identified SRS antenna switching configuration to the base station in response to determining that the identified SRS antenna switching configuration is different from the last transmitted SRS antenna switching configuration.

In another example, the at least one condition or option may include the currently active SRS antenna switching configuration. That is, the UE may compare the identified SRS antenna switching configuration to the currently active suitable SRS antenna switching configuration, and may determine to transmit the identified SRS antenna switching configuration to the base station in response to determining that the identified SRS antenna switching configuration is different from the currently active SRS antenna switching configuration.

In another example, the at least one condition or option may include an RRC reconfiguration message or MAC-CE. That is, the base station may determine to reconfigure the SRS resource (set) and transmit the RRC reconfiguration signal or MAC-CE to reconfigure/activate/deactivate the SRS antenna switching configuration for the UE. That is, the UE may receive the RRC reconfiguration signal or the MAC-CE reconfiguring/activating/deactivating the SRS antenna switching configuration from the base station and determine to identify and transmit the suitable SRS antenna switching configuration to the base station based on receiving the RRC reconfiguration signal or the MAC-CE. Here, the base station may transmit the RRC reconfiguration signal or the MAC-CE to reconfigure/activate/deactivate the SRS antenna switching configuration via a first signaling radio bearer (SRB1), and the UE may report the suitable SRS antenna switching configuration in response to the SRB1 received from the base station.

In another example, the network including the base station may send an RRC request message, e.g., a dedicated RRC signaling, to request the UE to report the suitable SRS antenna switching configuration, and the UE may report the suitable SRS antenna switching configuration message to the base station. Here, the dedicated RRC request transmitted from the base station may be applicable to the dedicated UL RRC message or the MAC-CE indicating the suitable SRS antenna switching configuration to the base station. For example, the network may activate/deactivate the SRS resource (set) via a DL MAC-CE, and the UE may report the suitable SRS antenna switching configuration MAC CE to the base station.

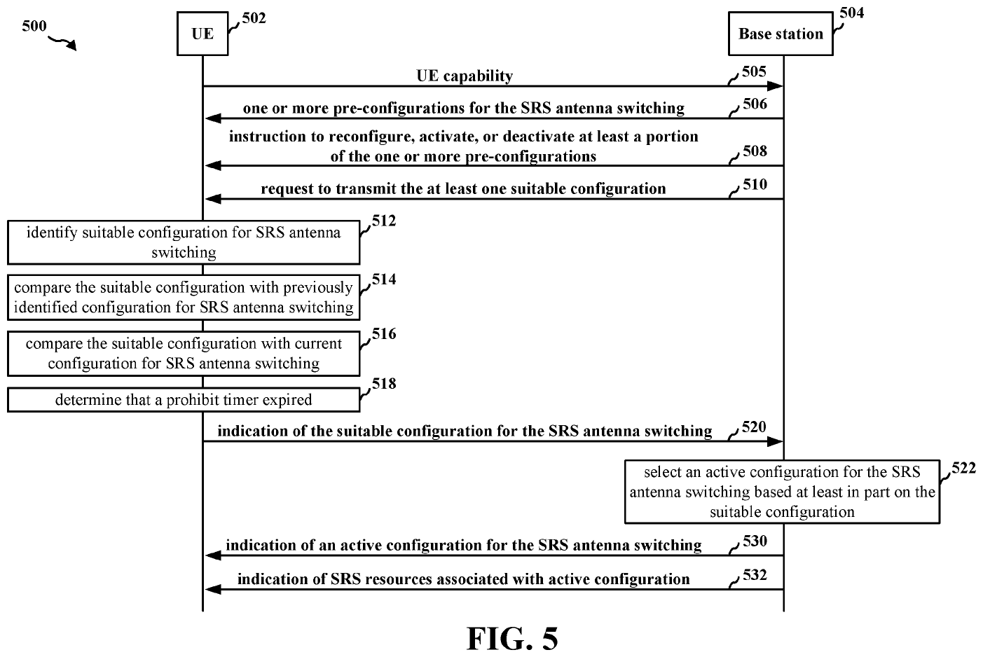

FIG. 5 is a call-flow diagram 500 of a method of wireless communication. The call-flow diagram 500 may include a UE 502 and a base station 504. The UE 502 may identify at least one suitable configuration for SRS antenna switching and transmit the at least one suitable configuration for SRS antenna switching to a base station 504 via a MAC-CE or an RRC message. The base station 504 may receive the at least one suitable configuration for SRS antenna switching from the UE 502 and transmit an active SRS antenna switching configuration to the UE 502, the active SRS antenna switching configuration based on the suitable configuration for SRS antenna switching received from the UE 502.

At 505, the UE 502 may transmit a UE capability indicating one or more SRS antenna switching configurations supported by the UE 502. The base station 504 may receive the UE capability indicating the one or more SRS antenna switching configurations supported by the UE 502. Here, the base station 504 may transmit one or more pre-configurations for the SRS antenna switching based on the UE capability. Furthermore, the UE capability may indicate one SRS antenna switching configuration supported by the UE 502, and the one or more pre-configurations for the SRS antenna switching may be fallback or subset configurations of the one SRS antenna switching configuration.

At 506, the UE 502 may receive one or more pre-configurations for the SRS antenna switching. The base station 504 may transmit the one or more pre-configurations for the SRS antenna switching. Here, the base station 504 may transmit the one or more pre-configurations for the SRS antenna switching based on the at least one combination of SRS antenna switching configurations supported by the UE 502. The UE 502 may identify at least one suitable configuration for the SRS antenna switching as a subset of the one or more pre-configurations for the SRS antenna switching.

At 508, the UE 502 may receive, from the base station 504 an instruction to reconfigure, activate, or deactivate at least a portion of the one or more pre-configurations for the SRS antenna switching. The base station 504 may transmit, to the UE 502, the instruction to reconfigure, activate, or deactivate at least a portion of the one or more pre-configurations for the SRS antenna switching. Here, the UE 502 may identify and transmit the at least one suitable configuration for SRS antenna switching to the base station 504 based on the instruction to reconfigure, activate, or deactivate at least a portion of the one or more pre-configurations for the SRS antenna switching. Here, the instruction to reconfigure, activate, or deactivate at least a portion of the one or more pre-configurations for the SRS antenna switching may be received via RRC signaling or a MAC-CE.

At 510, the UE 502 may receive, from the base station 504, a request to transmit the at least one suitable configuration. The base station 504 may transmit, to the UE 502, the request to transmit the at least one suitable configuration. Here, the UE 502 may identify and transmit the at least one suitable configuration for SRS antenna switching to the base station 504 based on the request to transmit the at least one suitable configuration received from the base station 504. In one aspect, the request may be received via an RRC message.

At 512, the UE 502 may identify at least one suitable configuration for SRS antenna switching. Here, the UE 502 may determine the at least one suitable configuration for SRS antenna switching based on at least one of the UE's condition or the network condition. Here, the UE's condition may include UE's power consumption, expected traffic in the UL/DL transmissions, UE RRC states, etc., and the network condition may include the channel condition, BWP, etc.

At 514, the UE 502 may compare the at least one suitable configuration with a previously identified configuration for the SRS antenna switching. Here, the UE 502 may transmit the indication of the at least one suitable configuration based on the at least one suitable configuration being different from the previously identified configuration for the SRS antenna switching.

At 516, the UE 502 may compare the at least one suitable configuration with a current configuration for the SRS antenna switching. Here, the UE 502 may transmit the indication of the at least one suitable configuration based on the at least one suitable configuration being different from the current configuration for the SRS antenna switching.

At 518, the UE 502 may determine that a timer associated with the previously identified configuration for the SRS antenna switching expired. Here, the timer may be a prohibit timer, and the UE may transmit the indication of the at least one suitable configuration based on determining that the prohibit timer expired. That is, the UE 502 may start the prohibit timer in response to reporting the suitable SRS antenna switching configuration in the MAC-CE or the RRC message, and the UE 502 may be prohibited from reporting the suitable SRS antenna switching configuration to the base station 504 while the prohibit timer is running.

At 520, the UE 502 may transmit, to the base station 504, an indication of the at least one suitable configuration for the SRS antenna switching. The base station 504 may receive, from the UE 502, the indication of the at least one suitable configuration for the SRS antenna switching.

In some aspects, the UE 502 may be configured to report the suitable SRS antenna switching configuration to the base station 504 in response to meeting at least one condition. That is, the UE 502 may determine whether at least one condition is met, and based on determining that the at least one condition is being met, may report the suitable SRS antenna switching configuration to the base station 504. In one aspect, the UE 502 may transmit the indication of the at least one suitable configuration based on the at least one suitable configuration being different from the previously identified configuration for the SRS antenna switching at 514. In another aspect, the UE 502 may transmit the indication of the at least one suitable configuration based on the at least one suitable configuration being different from the current configuration for the SRS antenna switching at 516. In another aspect, the UE 502 may transmit the indication of the at least one suitable configuration to the base station 504 based on the instruction received at 508. In another aspect, the UE 502 may transmit the at least one suitable configuration for SRS antenna switching to the base station 504 based on the request to transmit the at least one suitable configuration received from the base station 504 at 510, and the UE 502 may transmit the indication of the at least one suitable configuration via a dedicated RRC message.

In some aspects, the indication of the at least one suitable configuration for the SRS antenna switching may be transmitted via a MAC-CE. In one aspect, the MAC-CE may include a bitmap, each bit in the bitmap representing the at least one suitable configuration as the subset of the one or more pre-configurations for the SRS antenna switching. In another aspect, the MAC-CE may include a set of IDs representing the at least one suitable configuration identified from the one or more pre-configurations for the SRS antenna switching. In another aspect, the MAC-CE may include one or more sets of bits, each set of bits including at least one bit representing a first number of Tx antennae and at least one bit representing a second number of Rx antennae.

In some aspects, the indication of the at least one suitable configuration may be transmitted via an RRC message. In one aspect, the indication of the at least one suitable configuration may be reported as a dedicated parameter or an information element (IE), e.g., Suitable_SRS_Antenna_Switching, in an RRC message transmitted to the base station 504, e.g., UEAssistanceInformation. In another aspect, the indication of the at least one suitable configuration may be reported as a dedicated UL RRC message, and the content of the dedicated RRC message of the SRS antenna switching configuration may be substantially the same as the parameter or the IE, e.g., Suitable_SRS_Antenna_Switching, indicating the suitable antenna switching configuration in the RRC message, e.g., UEAssistanceInformation. When the UE 502 transmits the at least one suitable configuration for SRS antenna switching to the base station 504 based on the request to transmit the at least one suitable configuration received from the base station 504 at 510, the UE 502 may transmit the indication of the at least one suitable configuration via the dedicated RRC message.

In some aspects, the base station 504 may configure a prohibit timer for the UE 502, and the UE 502 may transmit the at least one suitable configuration for the SRS antenna switching when the prohibit timer is not running or expired. That is, the UE 502 may start the prohibit timer in response to reporting the suitable SRS antenna switching configuration to the base station 504, and the UE 502 may prohibit from reporting the suitable SRS antenna switching configuration to the base station 504 while the prohibit timer is running. The prohibit timer may be configured for at least one of the MAC-CE or the RRC message indicating the at least one suitable configuration for SRS antenna switching.

At 522, the base station 504 may select an active configuration for the SRS antenna switching based at least in part on the at least one suitable configuration for the SRS antenna switching. The base station 504 may determine the active configuration for the SRS antenna switching based at least in part on at least one of the at least one suitable configuration for the SRS antenna switching, the base station's condition, or the network condition. Here, the base station's condition may include the base station's power consumption, expected traffic in the UL/DL transmissions at the base station 504, available network resources, etc. In one aspect, the base station 504 may be configured to select one or more suitable SRS antenna switching configuration as the active configuration for the SRS antenna switching. In another aspect, the base station 504 may find that the at least one suitable SRS antenna switching configuration are not acceptable, and the active configuration for the SRS antenna switching may not be selected among the at least one suitable configuration for SRS antenna switching.

At 530, the UE 502 may receive, from the base station 504, an indication of an active configuration for the SRS antenna switching based at least in part on the at least one suitable configuration. The base station 504 may transmit, to the UE 502, the indication of the active configuration for the SRS antenna switching based at least in part on the at least one suitable configuration.

At 532, the UE 502 may receive, from the base station 504, an indication of one or more SRS resources associated with the active configuration for the SRS antenna switching. The base station 504 may transmit, to the UE 502, the indication of one or more SRS resources associated with the active configuration for the SRS antenna switching. The SRS resources may be associated with the active configuration for the SRS antenna switching. The UE 502 may transmit, to the base station 504, the SRS antenna switching to the base station 504 based on the one or more SRS resources and the active configuration for the SRS antenna switching. The base station 504 may receive, from the UE 502, the SRS antenna switching to the base station 504 based on the one or more SRS resources and the active configuration for the SRS antenna switching.

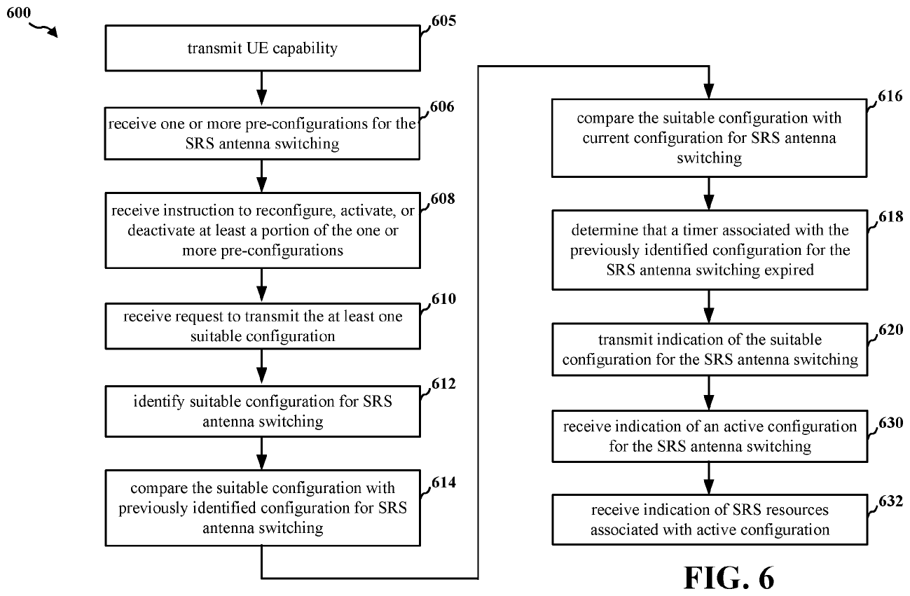

FIG. 6 is a flowchart 600 of a method of wireless communication. The method may be performed by a UE (e.g., the UE 104/502; the apparatus 1002). The UE may identify at least one suitable configuration for SRS antenna switching and transmit the at least one suitable configuration for SRS antenna switching to a base station via a MAC-CE or an RRC message.

At 605, the UE may transmit a UE capability indicating one or more SRS antenna switching configurations supported by the UE. Here, the base station may transmit one or more pre-configurations for the SRS antenna switching based on the UE capability. Furthermore, the UE capability may indicate one SRS antenna switching configuration supported by the UE, and the one or more pre-configurations for the SRS antenna switching may be fallback or subset configurations of the one SRS antenna switching configuration. For example, at 505, the UE 502 may transmit a UE capability indicating one or more SRS antenna switching configurations supported by the UE 502. Furthermore, 605 may be performed by a UE capability component 1040.

At 606, the UE may receive one or more pre-configurations for the SRS antenna switching. Here, the base station may transmit the one or more pre-configurations for the SRS antenna switching based on the at least one combination of SRS antenna switching configurations supported by the UE. The UE may identify at least one suitable configuration for the SRS antenna switching as a subset of the one or more pre-configurations for the SRS antenna switching. For example, at 506, the UE 502 may receive one or more pre-configurations for the SRS antenna switching. Furthermore, 606 may be performed by an SRS antenna switching configuration component 1042.

At 608, the UE may receive, from the base station, an instruction to reconfigure, activate, or deactivate at least a portion of the one or more pre-configurations for the SRS antenna switching. Here, the UE may identify and transmit the at least one suitable configuration for SRS antenna switching to the base station based on the instruction to reconfigure, activate, or deactivate at least a portion of the one or more pre-configurations for the SRS antenna switching. Here, the instruction to reconfigure, activate, or deactivate at least a portion of the one or more pre-configurations for the SRS antenna switching may be received via RRC signaling or a MAC-CE. For example, at 508, the UE 502 may receive, from the base station 504 an instruction to reconfigure, activate, or deactivate at least a portion of the one or more pre-configurations for the SRS antenna switching. Furthermore, 608 may be performed by the SRS antenna switching configuration component 1042.

At 610, the UE may receive, from the base station, a request to transmit the at least one suitable configuration. Here, the UE may identify and transmit the at least one suitable configuration for SRS antenna switching to the base station based on the request to transmit the at least one suitable configuration received from the base station 504. In one aspect, the request may be received via an RRC message. For example, at 510, the UE 502 may receive, from the base station 504, a request to transmit the at least one suitable configuration. Furthermore, 610 may be performed by the SRS antenna switching configuration component 1042.

At 612, the UE may identify at least one suitable configuration for SRS antenna switching. Here, the UE may determine the at least one suitable configuration for SRS antenna switching based on at least one of the UE's condition or the network condition. Here, the UE's condition may include UE's power consumption, expected traffic in the UL/DL transmissions, UE RRC states, etc., and the network condition may include the channel condition, BWP, etc. For example, at 512, the UE 502 may identify at least one suitable configuration for SRS antenna switching. Furthermore, 612 may be performed by a suitable SRS antenna switching configuration component 1044.

At 614, the UE may compare the at least one suitable configuration with a previously identified configuration for the SRS antenna switching. Here, the UE may transmit the indication of the at least one suitable configuration based on the at least one suitable configuration being different from the previously identified configuration for the SRS antenna switching. For example, at 514, the UE 502 may compare the at least one suitable configuration with a previously identified configuration for the SRS antenna switching. Furthermore, 614 may be performed by the suitable SRS antenna switching configuration component 1044.

At 616, the UE may compare the at least one suitable configuration with a current configuration for the SRS antenna switching. Here, the UE may transmit the indication of the at least one suitable configuration based on the at least one suitable configuration being different from the current configuration for the SRS antenna switching. For example, at 516, the UE 502 may compare the at least one suitable configuration with a current configuration for the SRS antenna switching. Furthermore, 616 may be performed by the suitable SRS antenna switching configuration component 1044.

At 618, the UE may determine that a timer associated with the previously identified configuration for the SRS antenna switching expired. Here, the timer may be a prohibit timer, and the UE may transmit the indication of the at least one suitable configuration based on determining that the prohibit timer expired. That is, the UE may start the prohibit timer in response to reporting the suitable SRS antenna switching configuration in the MAC-CE or the RRC message, and the UE may be prohibited from reporting the suitable SRS antenna switching configuration to the base station while the prohibit timer is running. For example, at 518, the UE 502 may determine that a timer associated with the previously identified configuration for the SRS antenna switching expired. Furthermore, 618 may be performed by the suitable SRS antenna switching configuration component 1044.

At 620, the UE may transmit, to the base station, an indication of the at least one suitable configuration for the SRS antenna switching. For example, at 520, the UE 502 may transmit, to the base station 504, an indication of the at least one suitable configuration for the SRS antenna switching. Furthermore, 620 may be performed by the suitable SRS antenna switching configuration component 1044.

In some aspects, the UE may be configured to report the suitable SRS antenna switching configuration to the base station in response to meeting at least one condition. That is, the UE may determine whether at least one condition is met, and based on determining that the at least one condition is being met, may report the suitable SRS antenna switching configuration to the base station. In one aspect, the UE may transmit the indication of the at least one suitable configuration based on the at least one suitable configuration being different from the previously identified configuration for the SRS antenna switching at 614. In another aspect, the UE may transmit the indication of the at least one suitable configuration based on the at least one suitable configuration being different from the current configuration for the SRS antenna switching at 616. In another aspect, the UE may transmit the indication of the at least one suitable configuration to the base station based on the instruction received at 608. In another aspect, the UE may transmit the at least one suitable configuration for SRS antenna switching to the base station based on the request to transmit the at least one suitable configuration received from the base station at 610, and the UE may transmit the indication of the at least one suitable configuration via a dedicated RRC message.

In some aspects, the indication of the at least one suitable configuration for the SRS antenna switching may be transmitted via a MAC-CE. In one aspect, the MAC-CE may include a bitmap, each bit in the bitmap representing the at least one suitable configuration as the subset of the one or more pre-configurations for the SRS antenna switching. In another aspect, the MAC-CE may include a set of IDs representing the at least one suitable configuration identified from the one or more pre-configurations for the SRS antenna switching. In another aspect, the MAC-CE may include one or more sets of bits, each set of bits including at least one bit representing a first number of Tx antennae and at least one bit representing a second number of Rx antennae.

In some aspects, the indication of the at least one suitable configuration may be transmitted via an RRC message. In one aspect, the indication of the at least one suitable configuration may be reported as a dedicated parameter or an information element (IE), e.g., Suitable_SRS_Antenna_Switching, in an RRC message transmitted to the base station, e.g., UEAssistanceInformation. In another aspect, the indication of the at least one suitable configuration may be reported as a dedicated UL RRC message, and the content of the dedicated RRC message of the SRS antenna switching configuration may be substantially the same as the parameter or the IE, e.g., Suitable_SRS_Antenna_Switching, indicating the suitable antenna switching configuration in the RRC message, e.g., UEAssistanceInformation. When the UE transmits the at least one suitable configuration for SRS antenna switching to the base station based on the request to transmit the at least one suitable configuration received from the base station at 610, the UE may transmit the indication of the at least one suitable configuration via the dedicated RRC message.

In some aspects, the base station may configure a prohibit timer for the UE, and the UE may transmit the at least one suitable configuration for the SRS antenna switching when the prohibit timer is not running or expired. That is, the UE may start the prohibit timer in response to reporting the suitable SRS antenna switching configuration to the base station, and the UE may prohibit from reporting the suitable SRS antenna switching configuration to the base station while the prohibit timer is running. The prohibit timer may be configured for at least one of the MAC-CE or the RRC message indicating the at least one suitable configuration for SRS antenna switching.

At 630, the UE may receive, from the base station, an indication of an active configuration for the SRS antenna switching based at least in part on the at least one suitable configuration. For example, at 530, the UE 502 may receive, from the base station 504, an indication of an active configuration for the SRS antenna switching based at least in part on the at least one suitable configuration. Furthermore, 630 may be performed by the SRS antenna switching configuration component 1042.

At 632, the UE may receive, from the base station, an indication of one or more SRS resources associated with the active configuration for the SRS antenna switching. The SRS resources may be associated with the active configuration for the SRS antenna switching. The UE may transmit, to the base station, the SRS antenna switching to the base station based on the one or more SRS resources and the active configuration for the SRS antenna switching. The base station may receive, from the UE, the SRS antenna switching to the base station based on the one or more SRS resources and the active configuration for the SRS antenna switching. For example, at 532, the UE 502 may receive, from the base station 504, an indication of one or more SRS resources associated with the active configuration for the SRS antenna switching. Furthermore, 632 may be performed by an SRS antenna switching component 1046.

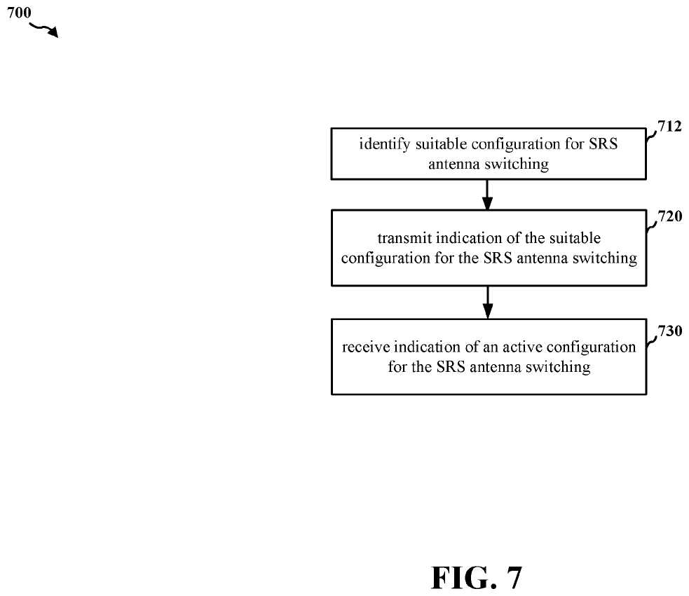

FIG. 7 is a flowchart 700 of a method of wireless communication. The method may be performed by a UE (e.g., the UE 104/502; the apparatus 1002). The UE may identify at least one suitable configuration for SRS antenna switching and transmit the at least one suitable configuration for SRS antenna switching to a base station via a MAC-CE or an RRC message.

At 712, the UE may identify at least one suitable configuration for SRS antenna switching. Here, the UE may determine the at least one suitable configuration for SRS antenna switching based on at least one of the UE's condition or the network condition. Here, the UE's condition may include UE's power consumption, expected traffic in the UL/DL transmissions, UE RRC states, etc., and the network condition may include the channel condition, BWP, etc. For example, at 512, the UE 502 may identify at least one suitable configuration for SRS antenna switching. Furthermore, 712 may be performed by a suitable SRS antenna switching configuration component 1044.

At 720, the UE may transmit, to the base station, an indication of the at least one suitable configuration for the SRS antenna switching. For example, at 520, the UE 502 may transmit, to the base station 504, an indication of the at least one suitable configuration for the SRS antenna switching. Furthermore, 720 may be performed by the suitable SRS antenna switching configuration component 1044.

In some aspects, the UE may be configured to report the suitable SRS antenna switching configuration to the base station in response to meeting at least one condition. That is, the UE may determine whether at least one condition is met, and based on determining that the at least one condition is being met, may report the suitable SRS antenna switching configuration to the base station. In one aspect, the UE may transmit the indication of the at least one suitable configuration based on the at least one suitable configuration being different from the previously identified configuration for the SRS antenna switching at 714. In another aspect, the UE may transmit the indication of the at least one suitable configuration based on the at least one suitable configuration being different from the current configuration for the SRS antenna switching at 716. In another aspect, the UE may transmit the indication of the at least one suitable configuration to the base station based on the instruction received at 708. In another aspect, the UE may transmit the at least one suitable configuration for SRS antenna switching to the base station based on the request to transmit the at least one suitable configuration received from the base station at 710, and the UE may transmit the indication of the at least one suitable configuration via a dedicated RRC message.

In some aspects, the indication of the at least one suitable configuration for the SRS antenna switching may be transmitted via a MAC-CE. In one aspect, the MAC-CE may include a bitmap, each bit in the bitmap representing the at least one suitable configuration as the subset of the one or more pre-configurations for the SRS antenna switching. In another aspect, the MAC-CE may include a set of IDs representing the at least one suitable configuration identified from the one or more pre-configurations for the SRS antenna switching. In another aspect, the MAC-CE may include one or more sets of bits, each set of bits including at least one bit representing a first number of Tx antennae and at least one bit representing a second number of Rx antennae.

In some aspects, the indication of the at least one suitable configuration may be transmitted via an RRC message. In one aspect, the indication of the at least one suitable configuration may be reported as a dedicated parameter or an information element (IE), e.g., Suitable_SRS_Antenna_Switching, in an RRC message transmitted to the base station, e.g., UEAssistanceInformation. In another aspect, the indication of the at least one suitable configuration may be reported as a dedicated UL RRC message, and the content of the dedicated RRC message of the SRS antenna switching configuration may be substantially the same as the parameter or the IE, e.g., Suitable_SRS_Antenna_Switching, indicating the suitable antenna switching configuration in the RRC message, e.g., UEAssistanceInformation. When the UE transmits the at least one suitable configuration for SRS antenna switching to the base station based on the request to transmit the at least one suitable configuration received from the base station at 710, the UE may transmit the indication of the at least one suitable configuration via the dedicated RRC message.

In some aspects, the base station may configure a prohibit timer for the UE, and the UE may transmit the at least one suitable configuration for the SRS antenna switching when the prohibit timer is not running or expired. That is, the UE may start the prohibit timer in response to reporting the suitable SRS antenna switching configuration to the base station, and the UE may prohibit from reporting the suitable SRS antenna switching configuration to the base station while the prohibit timer is running. The prohibit timer may be configured for at least one of the MAC-CE or the RRC message indicating the at least one suitable configuration for SRS antenna switching.

At 730, the UE may receive, from the base station, an indication of an active configuration for the SRS antenna switching based at least in part on the at least one suitable configuration. For example, at 530, the UE 502 may receive, from the base station 504, an indication of an active configuration for the SRS antenna switching based at least in part on the at least one suitable configuration. Furthermore, 730 may be performed by the SRS antenna switching configuration component 1042.

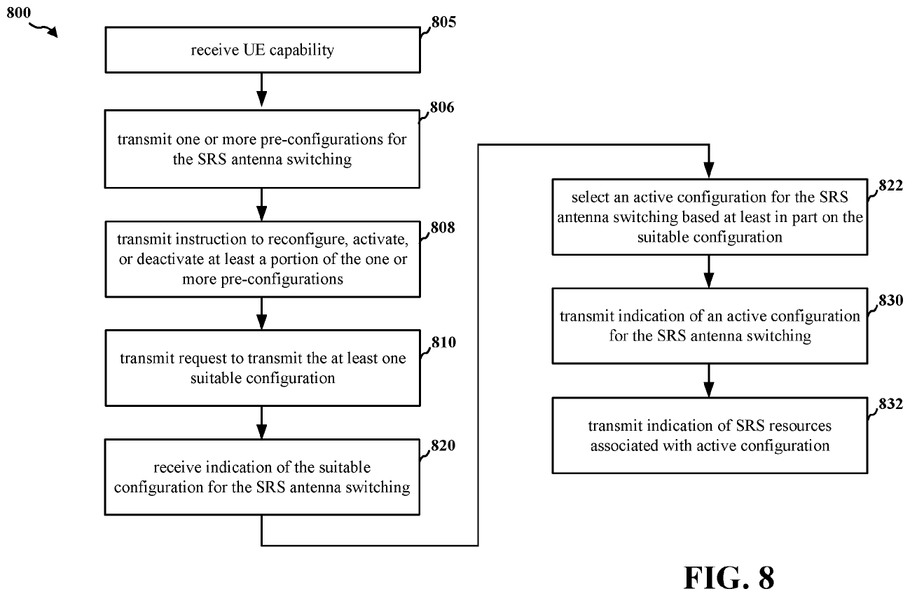

FIG. 8 is a flowchart 800 of a method of wireless communication. The method may be performed by a base station (e.g., the base station 102/180/504; the apparatus 1102). The base station may receive at least one suitable configuration for SRS antenna switching from the UE via a MAC-CE or an RRC message and transmit an active SRS antenna switching configuration to the UE, the active SRS antenna switching configuration based on the suitable configuration for SRS antenna switching received from the UE.

At 805, the base station may receive a UE capability indicating one or more SRS antenna switching configurations supported by the UE. For example, at 505, the base station 504 may receive the UE capability indicating the one or more SRS antenna switching configurations supported by the UE 502. Furthermore, 805 may be performed by a UE capability component 1140.

At 806, the base station may transmit the one or more pre-configurations for the SRS antenna switching. Here, the base station may transmit the one or more pre-configurations for the SRS antenna switching based on the at least one of a combination of SRS antenna switching configurations supported by the UE. The UE may identify at least one suitable configuration for the SRS antenna switching as a subset of the one or more pre-configurations for the SRS antenna switching. For example, at 506, the base station 504 may transmit the one or more pre-configurations for the SRS antenna switching. Furthermore, 806 may be performed by an SRS antenna switching configuration component 1142.

At 808, the base station may transmit, to the UE, the instruction to reconfigure, activate, or deactivate at least a portion of the one or more pre-configurations for the SRS antenna switching. Here, the UE may identify and transmit the at least one suitable configuration for SRS antenna switching to the base station based on the instruction to reconfigure, activate, or deactivate at least a portion of the one or more pre-configurations for the SRS antenna switching. For example, at 508, the base station 504 may transmit, to the UE 502, the instruction to reconfigure, activate, or deactivate at least a portion of the one or more pre-configurations for the SRS antenna switching. Furthermore, 808 may be performed by the SRS antenna switching configuration component 1142.

At 810, the base station may transmit, to the UE, the request to transmit the at least one suitable configuration. Here, the UE may identify and transmit the at least one suitable configuration for SRS antenna switching to the base station based on the request to transmit the at least one suitable configuration received from the base station 504. In one aspect, the request may be received via an RRC message. For example, at 510, the base station 504 may transmit, to the UE 502, the request to transmit the at least one suitable configuration. Furthermore, 810 may be performed by the SRS antenna switching configuration component 1142.

At 820, the base station may receive, from the UE, the indication of the at least one suitable configuration for the SRS antenna switching. For example, at 520, the base station 504 may receive, from the UE 502, the indication of the at least one suitable configuration for the SRS antenna switching. Furthermore, 820 may be performed by a suitable SRS antenna switching configuration component 1144.

In some aspects, the base station may be configured to receive the suitable SRS antenna switching configuration from the UE in response to meeting at least one condition. That is, the UE may determine whether at least one condition is met, and the base station may receive the suitable SRS antenna switching configuration from the UE based on the UE determining that the at least one condition is being met. In one aspect, the base station may receive the indication of the at least one suitable configuration from the UE based on the instruction received at 808. In another aspect, the base station may receive the at least one suitable configuration for SRS antenna switching from the UE based on the request to transmit the at least one suitable configuration transmitted to the UE at 810, and the base station may receive the indication of the at least one suitable configuration via a dedicated RRC message.

In some aspects, the indication of the at least one suitable configuration for the SRS antenna switching may be received via a MAC-CE. In one aspect, the MAC-CE may include a bitmap, each bit in the bitmap representing the at least one suitable configuration as the subset of the one or more pre-configurations for the SRS antenna switching. In another aspect, the MAC-CE may include a set of IDs representing the at least one suitable configuration identified from the one or more pre-configurations for the SRS antenna switching. In another aspect, the MAC-CE may include one or more sets of bits, each set of bits including at least one bit representing a first number of Tx antennae and at least one bit representing a second number of Rx antennae.

In some aspects, the indication of the at least one suitable configuration may be received via an RRC message. In one aspect, the indication of the at least one suitable configuration may be received as a dedicated parameter or an information element (IE), e.g., Suitable_SRS_Antenna_Switching, in an RRC message received from the UE, e.g., UEAssistanceInformation. In another aspect, the indication of the at least one suitable configuration may be reported as a dedicated UL RRC message, and the content of the dedicated RRC message of the SRS antenna switching configuration may be substantially the same as the parameter or the IE, e.g., Suitable_SRS_Antenna_Switching, indicating the suitable antenna switching configuration in the RRC message, e.g., UEAssistanceInformation. When the base station receives the at least one suitable configuration for SRS antenna switching to the base station based on the request to transmit the at least one suitable configuration received from the base station at 810, the base station may receive the indication of the at least one suitable configuration via the dedicated RRC message.

In some aspects, the base station may configure a prohibit timer for the UE, and the UE may transmit the at least one suitable configuration for the SRS antenna switching when the prohibit timer is not running or expired. That is, the UE may start the prohibit timer in response to reporting the suitable SRS antenna switching configuration to the base station, and the base station may not expect to receive the suitable SRS antenna switching configuration from the UE while the prohibit timer is running. The prohibit timer may be configured for at least one of the MAC-CE or the RRC message indicating the at least one suitable configuration for SRS antenna switching.

At 822, the base station may select an active configuration for the SRS antenna switching based at least in part on the at least one suitable configuration for the SRS antenna switching. The base station may determine the active configuration for the SRS antenna switching based at least in part on at least one of the at least one suitable configuration for the SRS antenna switching, the base station's condition, or the network condition. Here, the base station's condition may include the base station's power consumption, expected traffic in the UL/DL transmissions at the base station, available network resources, etc. In one aspect, the base station may be configured to select one or more suitable SRS antenna switching configurations as the active configuration for the SRS antenna switching. In another aspect, the base station may find that the at least one suitable SRS antenna switching configuration are not acceptable, and the active configuration for the SRS antenna switching may not be selected among the at least one suitable configuration for SRS antenna switching. For example, at 522, the base station 504 may select an active configuration for the SRS antenna switching based at least in part on the at least one suitable configuration for the SRS antenna switching. Furthermore, 822 may be performed by the SRS antenna switching configuration component 1142.

At 830, the base station may transmit, to the UE, the indication of the active configuration for the SRS antenna switching based at least in part on the at least one suitable configuration. For example, at 530, the base station 504 may transmit, to the UE 502, the indication of the active configuration for the SRS antenna switching based at least in part on the at least one suitable configuration. Furthermore, 830 may be performed by the SRS antenna switching configuration component 1142.

At 832, the base station may transmit, to the UE, the indication of one or more SRS resources associated with the active configuration for the SRS antenna switching. The SRS resources may be associated with the active configuration for the SRS antenna switching. The UE may transmit, to the base station, the SRS antenna switching to the base station based on the one or more SRS resources and the active configuration for the SRS antenna switching. The base station may receive, from the UE, the SRS antenna switching to the base station based on the one or more SRS resources and the active configuration for the SRS antenna switching. For example, at 532, the base station 504 may transmit, to the UE 502, the indication of one or more SRS resources associated with the active configuration for the SRS antenna switching. Furthermore, 832 may be performed by an SRS antenna switching component 1146.

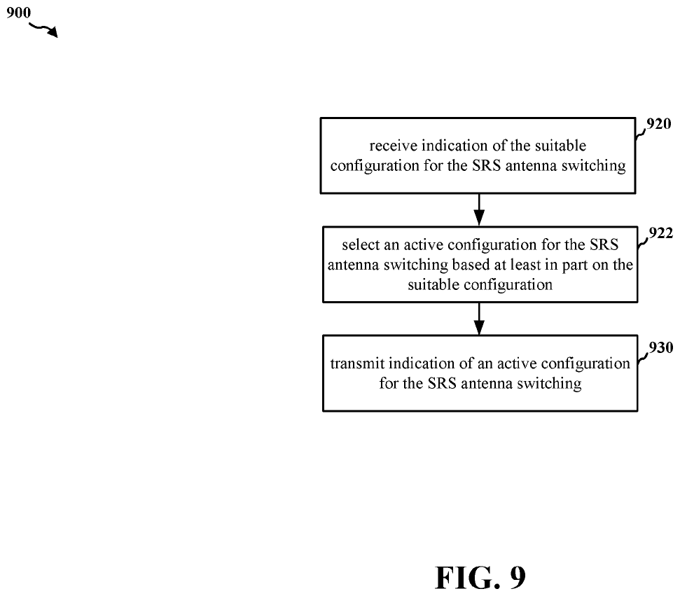

FIG. 9 is a flowchart 900 of a method of wireless communication. The method may be performed by a base station (e.g., the base station 102/180/504; the apparatus 1102). The base station may receive at least one suitable configuration for SRS antenna switching from the UE via a MAC-CE or an RRC message and transmit an active SRS antenna switching configuration to the UE, the active SRS antenna switching configuration based on the suitable configuration for SRS antenna switching received from the UE.

At 920, the base station may receive, from the UE, the indication of the at least one suitable configuration for the SRS antenna switching. For example, at 520, the base station 504 may receive, from the UE 502, the indication of the at least one suitable configuration for the SRS antenna switching. Furthermore, 920 may be performed by a suitable SRS antenna switching configuration component 1144.

In some aspects, the base station may be configured to receive the suitable SRS antenna switching configuration from the UE in response to meeting at least one condition. That is, the UE may determine whether at least one condition is met, and the base station may receive the suitable SRS antenna switching configuration from the UE based on the UE determining that the at least one condition is being met. In one aspect, the base station may receive the indication of the at least one suitable configuration from the UE based on the instruction received at 908. In another aspect, the base station may receive the at least one suitable configuration for SRS antenna switching from the UE based on the request to transmit the at least one suitable configuration transmitted to the UE at 910, and the base station may receive the indication of the at least one suitable configuration via a dedicated RRC message. In some aspects, the indication of the at least one suitable configuration for the SRS antenna switching may be received via a MAC-CE. In one aspect, the MAC-CE may include a bitmap, each bit in the bitmap representing the at least one suitable configuration as the subset of the one or more pre-configurations for the SRS antenna switching. In another aspect, the MAC-CE may include a set of IDs representing the at least one suitable configuration identified from the one or more pre-configurations for the SRS antenna switching. In another aspect, the MAC-CE may include one or more sets of bits, each set of bits including at least one bit representing a first number of Tx antennae and at least one bit representing a second number of Rx antennae.

In some aspects, the indication of the at least one suitable configuration may be received via an RRC message. In one aspect, the indication of the at least one suitable configuration may be received as a dedicated parameter or an information element (IE), e.g., Suitable_SRS_Antenna_Switching, in an RRC message received from the UE, e.g., UEAssistanceInformation. In another aspect, the indication of the at least one suitable configuration may be reported as a dedicated UL RRC message, and the content of the dedicated RRC message of the SRS antenna switching configuration may be substantially the same as the parameter or the IE, e.g., Suitable_SRS_Antenna_Switching, indicating the suitable antenna switching configuration in the RRC message, e.g., UEAssistanceInformation. When the base station receives the at least one suitable configuration for SRS antenna switching to the base station based on the request to transmit the at least one suitable configuration received from the base station at 910, the base station may receive the indication of the at least one suitable configuration via the dedicated RRC message.

In some aspects, the base station may configure a prohibit timer for the UE, and the UE may transmit the at least one suitable configuration for the SRS antenna switching when the prohibit timer is not running or expired. That is, the UE may start the prohibit timer in response to reporting the suitable SRS antenna switching configuration to the base station, and the base station may not expect to receive the suitable SRS antenna switching configuration from the UE while the prohibit timer is running. The prohibit timer may be configured for at least one of the MAC-CE or the RRC message indicating the at least one suitable configuration for SRS antenna switching.

At 922, the base station may select an active configuration for the SRS antenna switching based at least in part on the at least one suitable configuration for the SRS antenna switching. The base station may determine the active configuration for the SRS antenna switching based at least in part on at least one of the at least one suitable configuration for the SRS antenna switching, the base station's condition, or the network condition. Here, the base station's condition may include the base station's power consumption, expected traffic in the UL/DL transmissions at the base station, available network resources, etc. In one aspect, the base station may be configured to select one or more suitable SRS antenna switching configurations as the active configuration for the SRS antenna switching. In another aspect, the base station may find that the at least one suitable SRS antenna switching configuration are not acceptable, and the active configuration for the SRS antenna switching may not be selected among the at least one suitable configuration for SRS antenna switching. For example, at 522, the base station 504 may select an active configuration for the SRS antenna switching based at least in part on the at least one suitable configuration for the SRS antenna switching. Furthermore, 922 may be performed by the SRS antenna switching configuration component 1142.

At 930, the base station may transmit, to the UE, the indication of the active configuration for the SRS antenna switching based at least in part on the at least one suitable configuration. For example, at 530, the base station 504 may transmit, to the UE 502, the indication of the active configuration for the SRS antenna switching based at least in part on the at least one suitable configuration. Furthermore, 930 may be performed by the SRS antenna switching configuration component 1142.

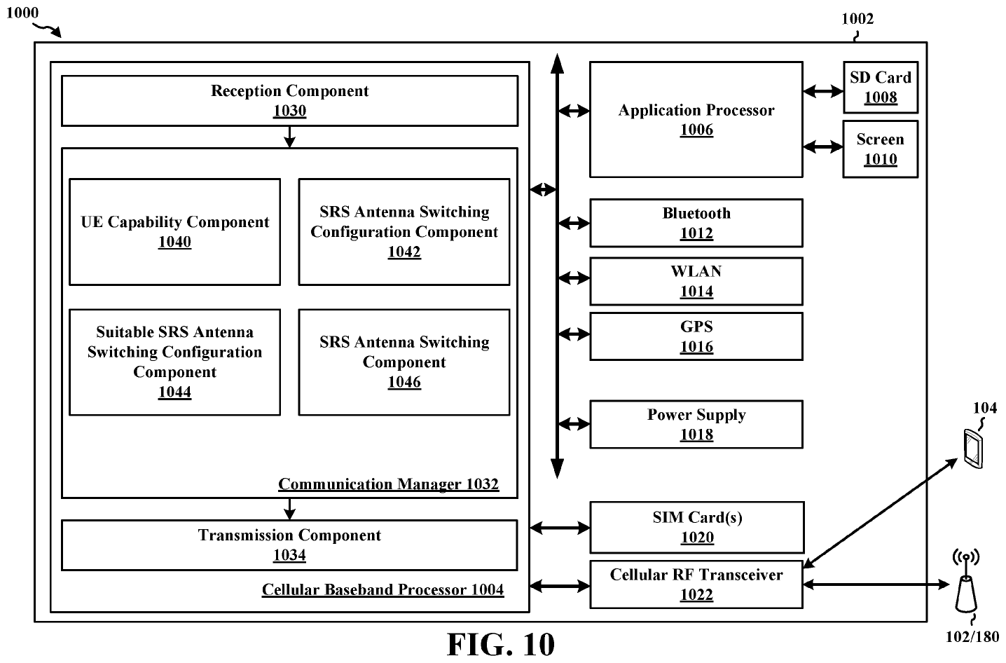

FIG. 10 is a diagram 1000 illustrating an example of a hardware implementation for an apparatus 1002. The apparatus 1002 may be a UE, a component of a UE, or may implement UE functionality. In some aspects, the apparatus 1002 may include a cellular baseband processor 1004 (also referred to as a modem) coupled to a cellular RF transceiver 1022. In some aspects, the apparatus 1002 may further include one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, or a power supply 1018. The cellular baseband processor 1004 communicates through the cellular RF transceiver 1022 with the UE 104 and/or BS 102/180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 1004 when executing software. The cellular baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 350 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see 350 of FIG. 3) and include the additional modules of the apparatus 1002.

The communication manager 1032 includes a UE capability component 1040 that is configured to transmit a UE capability indicating one or more SRS antenna switching configurations supported by the UE, e.g., as described in connection with 605. The communication manager 1032 further includes an SRS antenna switching configuration component 1042 that is configured to receive one or more pre-configurations for the SRS antenna switching, receive an instruction to reconfigure, activate, or deactivate at least a portion of the one or more pre-configurations for the SRS antenna switching, and receive a request to transmit the at least one suitable configuration, receive an indication of an active configuration for the SRS antenna switching based at least in part on the at least one suitable configuration, e.g., as described in connection with 606, 608, 610, 630, and 730. The communication manager 1032 includes a suitable SRS antenna switching configuration component 1044 that is configured to identify at least one suitable configuration for SRS antenna switching, compare the at least one suitable configuration with a previously identified configuration for the SRS antenna switching, compare the at least one suitable configuration with a current configuration for the SRS antenna switching, transmit an indication of the at least one suitable configuration for the SRS antenna switching, and determine whether a timer associated with the previously identified configuration for the SRS antenna switching expired, e.g., as described in connection with 612, 614, 616, 618, 620, 712, and 720. The communication manager 1032 includes an SRS antenna switching component 1046 that is configured to receive, an indication of one or more SRS resources associated with the active configuration for the SRS antenna switching, e.g., as described in connection with 632.

The apparatus may include additional components that perform each of the blocks of the algorithm in the flowcharts of FIGS. 5, 6, and 7. As such, each block in the flowcharts of FIGS. 5, 6, and 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1002 may include a variety of components configured for various functions. In one configuration, the apparatus 1002, and in particular the cellular baseband processor 1004, includes means for identifying at least one suitable configuration for SRS antenna switching, means for transmitting, to a base station, an indication of the at least one suitable configuration for the SRS antenna switching, means for receiving, from the base station, an indication of an active configuration for the SRS antenna switching based at least in part on the at least one suitable configuration, and means for receiving, from the base station, an indication of one or more SRS resources associated with the active configuration for the SRS antenna switching. The apparatus 1002 includes means for determining whether a timer associated with the previously identified configuration for the SRS antenna switching expired. The apparatus 1002 includes means for comparing the at least one suitable configuration with a previously identified configuration for the SRS antenna switching, and means for comparing the at least one suitable configuration with a current configuration for the SRS antenna switching. The apparatus 1002 includes means for receiving one or more pre-configurations for the SRS antenna switching, means for receiving an instruction to reconfigure, activate, or deactivate at least a portion of the one or more pre-configurations for the SRS antenna switching, and means for receiving, from the base station, a request to transmit the at least one suitable configuration. The means may be one or more of the components of the apparatus 1002 configured to perform the functions recited by the means. As described supra, the apparatus 1002 may include the TX Processor 368, the RX Processor 356, and the controller/processor 359. As such, in one configuration, the means may be the TX Processor 368, the RX Processor 356, and the controller/processor 359 configured to perform the functions recited by the means.

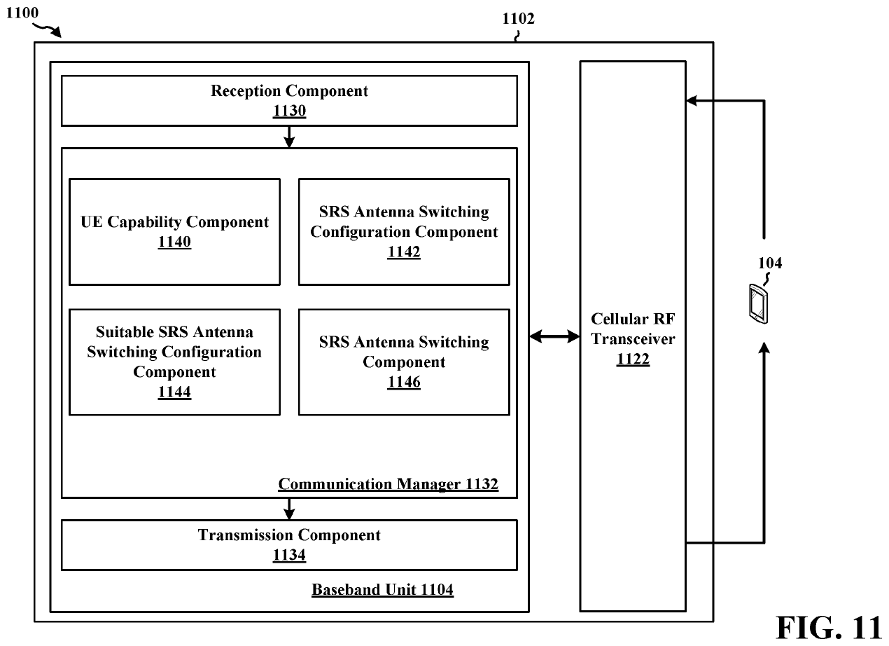

FIG. 11 is a diagram 1100 illustrating an example of a hardware implementation for an apparatus 1102. The apparatus 1102 may be a base station, a component of a base station, or may implement base station functionality. In some aspects, the apparatus 1002 may include a baseband unit 1104. The baseband unit 1104 may communicate through a cellular RF transceiver 1122 with the UE 104. The baseband unit 1104 may include a computer-readable medium/memory. The baseband unit 1104 is responsible for general processing, including the execution of software stored on the computer-readable medium/memory. The software, when executed by the baseband unit 1104, causes the baseband unit 1104 to perform the various functions described supra. The computer-readable medium/memory may also be used for storing data that is manipulated by the baseband unit 1104 when executing software. The baseband unit 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the baseband unit 1104. The baseband unit 1104 may be a component of the base station 310 and may include the memory 376 and/or at least one of the TX processor 316, the RX processor 370, and the controller/processor 375.

The communication manager 1132 includes a UE capability component 1140 that is configured to receive the UE capability indicating the one or more SRS antenna switching configurations supported by the UE, e.g., as described in connection with 805. The communication manager 1132 further includes an SRS antenna switching configuration component 1142 that is configured to transmit the one or more pre-configurations for the SRS antenna switching, transmit the instruction to reconfigure, activate, or deactivate at least a portion of the one or more pre-configurations for the SRS antenna switching, transmit, to the UE, the request to transmit the at least one suitable configuration, select an active configuration for the SRS antenna switching based at least in part on the at least one suitable configuration for the SRS antenna switching, and transmit, to the UE, the indication of the active configuration for the SRS antenna switching based at least in part on the at least one suitable configuration, e.g., as described in connection with 806, 808, 810, 822, 830, 922, and 930. The communication manager 1132 includes a suitable SRS antenna switching configuration component 1144 that is configured to receive the indication of the at least one suitable configuration for the SRS antenna switching, e.g., as described in connection with 820 and 920. The communication manager 1132 includes an SRS antenna switching component 1146 that is configured to transmit the indication of one or more SRS resources associated with the active configuration for the SRS antenna switching, e.g., as described in connection with 832.

The apparatus may include additional components that perform each of the blocks of the algorithm in the flowcharts of FIGS. 5, 8, and 9. As such, each block in the flowcharts of FIGS. 5, 8, and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1102 may include a variety of components configured for various functions. In one configuration, the apparatus 1102, and in particular the baseband unit 1104, includes means for receiving, from a UE, an indication of at least one suitable configuration for SRS antenna switching, means for selecting an active configuration for the SRS antenna switching based at least in part on the at least one suitable configuration for the SRS antenna switching, means for transmitting, to the UE, an indication of the active configuration for the SRS antenna switching, and means for transmitting, to the UE, an indication of one or more SRS resources associated with the active configuration for the SRS antenna switching. The apparatus 1102 includes means for transmitting, to the UE, one or more pre-configurations for the SRS antenna switching, means for transmitting, to the UE, an instruction to reconfigure, activate, or deactivate at least a portion of the one or more pre-configurations for the SRS antenna switching, and means for transmitting, to the UE, a request to transmit the at least one suitable configuration. The means may be one or more of the components of the apparatus 1102 configured to perform the functions recited by the means. As described supra, the apparatus 1102 may include the TX Processor 316, the RX Processor 370, and the controller/processor 375. As such, in one configuration, the means may be the TX Processor 316, the RX Processor 370, and the controller/processor 375 configured to perform the functions recited by the means.

A UE may identify at least one suitable configuration for SRS antenna switching, and transmit the at least one suitable configuration for SRS antenna switching to a base station via a MAC-CE or an RRC message. The base station may receive the at least one suitable configuration for SRS antenna switching from the UE, and transmit an active SRS antenna switching configuration to the UE, the active SRS antenna switching configuration based on the suitable configuration for SRS antenna switching received from the UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE, including at least one processor coupled to a memory, the at least one processor being configured to, at least in part with the memory, identify at least one suitable configuration for SRS antenna switching, transmit, to a base station, an indication of the at least one suitable configuration for the SRS antenna switching, and receive, from the base station, an indication of an active configuration for the SRS antenna switching based at least in part on the at least one suitable configuration.

Aspect 2 is the apparatus of aspect 1, further including a transceiver coupled to the at least one processor, where the at least one processor, at least in part with the memory, is further configured to receive, from the base station, an indication of one or more SRS resources associated with the active configuration for the SRS antenna switching.

Aspect 3 is the apparatus of any of aspects 1 and 2, where the indication of the at least one suitable configuration for the SRS antenna switching is transmitted via a MAC-CE.

Aspect 4 is the apparatus of any of aspects 1 to 3, where the at least one processor, at least in part with the memory, is further configured to receive, from the base station, one or more pre-configurations for the SRS antenna switching, the at least one suitable configuration for the SRS antenna switching being a subset of the one or more pre-configurations for the SRS antenna switching.

Aspect 5 is the apparatus of aspect 4, where the at least one processor, at least in part with the memory, is further configured to transmit a UE capability indicating one or more SRS antenna switching configurations supported by the UE, where the one or more pre-configurations for the SRS antenna switching are based on the UE capability.

Aspect 6 is the apparatus of aspect 5, where the UE capability indicates one SRS antenna switching configuration supported by the UE, and the one or more pre-configurations for the SRS antenna switching are fallback or subset configurations of the one SRS antenna switching configuration.

Aspect 7 is the apparatus of any of aspects 4 to 6, where the MAC-CE includes a bitmap, each bit in the bitmap representing the at least one suitable configuration as the subset of the one or more pre-configurations for the SRS antenna switching.

Aspect 8 is the apparatus of any of aspects 4 to 7, where the MAC-CE includes a set of IDs representing the at least one suitable configuration identified from the one or more pre-configurations for the SRS antenna switching.

Aspect 9 is the apparatus of any of aspects 3 to 8, where the MAC-CE includes one or more sets of bits, each set of bits including at least one bit representing a first number of Tx antennae and at least one bit representing a second number of Rx antennae.

Aspect 10 is the apparatus of any of aspects 1 to 9, where the indication of the at least one suitable configuration is transmitted via an RRC message.

Aspect 11 is the apparatus of any of aspects 1 to 10, where the at least one processor, at least in part with the memory, is further configured to compare the at least one suitable configuration with a previously identified configuration for the SRS antenna switching, where the indication of the at least one suitable configuration is transmitted based on the at least one suitable configuration being different from the previously identified configuration for the SRS antenna switching.

Aspect 12 is the apparatus of aspect of aspect 11, where the at least one processor, at least in part with the memory, is further configured to determine whether a timer associated with the previously identified configuration for the SRS antenna switching expired, where the indication of the at least one suitable configuration is transmitted further based on determining that the timer expired.

Aspect 13 is the apparatus of any of aspects 1 to 12, where the at least one processor, at least in part with the memory, is further configured to compare the at least one suitable configuration with a current configuration for the SRS antenna switching, where the indication of the at least one suitable configuration is transmitted based on the at least one suitable configuration being different from the current configuration for the SRS antenna switching.

Aspect 14 is the apparatus of any of aspects 1 to 13, where the at least one processor, at least in part with the memory, is further configured to receive one or more pre-configurations for the SRS antenna switching and receive an instruction to reconfigure, activate, or deactivate at least a portion of the one or more pre-configurations for the SRS antenna switching, where the at least one suitable configuration is identified as a subset of the one or more pre-configurations for the SRS antenna switching and the indication of the at least one suitable configuration is transmitted based on the received instruction.

Aspect 15 is the apparatus of aspect 14, where the instruction to reconfigure, activate, or deactivate at least a portion of the one or more pre-configurations for the SRS antenna switching is received via RRC signaling or a MAC-CE.

Aspect 16 is the apparatus of any of aspects 1 to 15, where the at least one processor, at least in part with the memory, is further configured to receive, from the base station, a request to transmit the at least one suitable configuration, where the at least one suitable configuration is identified and the indication of the at least one suitable configuration is transmitted based on the request to transmit the at least one suitable configuration.

Aspect 17 is a method of wireless communication for implementing any of aspects 1 to 16.

Aspect 18 is an apparatus for wireless communication including means for implementing any of aspects 1 to 16.

Aspect 19 is a computer-readable medium storing computer-executable code, where the code when executed by a processor causes the processor to implement any of aspects 1 to 16.

Aspect 20 is an apparatus for wireless communication at a base station, including at least one processor coupled to a memory, the at least one processor being configured to, at least in part with the memory, receive, from a UE, an indication of at least one suitable configuration for SRS antenna switching, select an active configuration for the SRS antenna switching based at least in part on the at least one suitable configuration for the SRS antenna switching, and transmit, to the UE, an indication of the active configuration for the SRS antenna switching.

Aspect 21 is the apparatus of aspect 20, further including a transceiver coupled to the at least one processor, where the at least one processor, at least in part with the memory, is are further configured to transmit, to the UE, an indication of one or more SRS resources associated with the active configuration for the SRS antenna switching.

Aspect 22 is the apparatus of any of aspects 20 and 21, where the indication of the at least one suitable configuration for the SRS antenna switching is received via a MAC-CE.

Aspect 23 is the apparatus of aspect 22, where the at least one processor, at least in part with the memory, are further configured to transmit, to the UE, one or more pre-configurations for the SRS antenna switching, the at least one suitable configuration for the SRS antenna switching being a subset of the one or more pre-configurations for the SRS antenna switching.

Aspect 24 is the apparatus of aspect 23, where the at least one processor, at least in part with the memory, is further configured to receive a UE capability indicating one or more SRS antenna switching configurations supported by the UE, where the one or more pre-configurations for the SRS antenna switching are based on the UE capability.

Aspect 25 is the apparatus of aspect 24, where the UE capability indicates one SRS antenna switching configuration supported by the UE, and the one or more pre-configurations for the SRS antenna switching are fallback or subset configurations of the one SRS antenna switching configuration.

Aspect 26 is the apparatus of aspect 23, where the MAC-CE includes a bitmap, each bit in the bitmap representing the at least one suitable configuration as the subset of the one or more pre-configurations for the SRS antenna switching.

Aspect 27 is the apparatus of any of aspects 23 to 26, where the MAC-CE includes a set of IDs representing the at least one suitable configuration as the subset of the one or more pre-configurations for the SRS antenna switching.

Aspect 28 is the apparatus of any of aspects 22 to 27, where the MAC-CE includes one or more sets of bits, each set of bits including at least one bit representing a first number of Tx antennae and at least one bit representing a second number of Rx antennae.

Aspect 29 is the apparatus of any of aspects 20 and 21, where the indication of the at least one suitable configuration is received via an RRC message.

Aspect 30 is the apparatus of any of aspects 20 to 29, where the at least one processor, at least in part with the memory, is further configured to transmit, to the UE, one or more pre-configurations for the SRS antenna switching, and transmit, to the UE, an instruction to reconfigure, activate, or deactivate at least a portion of the one or more pre-configurations for the SRS antenna switching, where the at least one suitable configuration is a subset of the one or more pre-configurations for the SRS antenna switching and the indication of the at least one suitable configuration is received based on the transmitted instruction.

Aspect 31 is the apparatus of aspect 30, where the instruction to reconfigure, activate, or deactivate at least a portion of the one or more pre-configurations for the SRS antenna switching is received via RRC signaling or a MAC-CE.

Aspect 32 is the apparatus of any of aspects 20 to 31, where the at least one processor, at least in part with the memory, is further configured to transmit, to the UE, a request to transmit the at least one suitable configuration, where the indication of the at least one suitable configuration is received based on the request to transmit the at least one suitable configuration.

Aspect 33 is a method of wireless communication for implementing any of aspects 20 to 32.

Aspect 34 is an apparatus for wireless communication including means for implementing any of aspects 20 to 32.

Aspect 35 is a computer-readable medium storing computer-executable code, where the code when executed by a processor causes the processor to implement any of aspects 20 to 32.

What is claimed is:

1. An apparatus for wireless communication at a user equipment (UE), comprising:
a memory; and
at least one processor coupled to the memory, the at least one processor being configured to, at least in part with the memory:
identify at least one suitable configuration for sounding reference signal (SRS) antenna switching;
transmit, to a base station, an indication of the at least one suitable configuration for the SRS antenna switching; and
receive, from the base station, an indication of an active configuration for the SRS antenna switching based at least in part on the at least one suitable configuration.

2. The apparatus of claim 1, further comprising a transceiver coupled to the at least one processor, wherein the at least one processor, at least in part with the memory, is further configured to:
receive, from the base station, an indication of one or more SRS resources associated with the active configuration for the SRS antenna switching.

3. The apparatus of claim 1, wherein the indication of the at least one suitable configuration for the SRS antenna switching is transmitted via a medium access control (MAC) control element (CE) (MAC-CE).

4. The apparatus of claim 3, wherein the at least one processor, at least in part with the memory, is further configured to:
receive, from the base station, one or more pre-configurations for the SRS antenna switching, the at least one suitable configuration for the SRS antenna switching being a subset of the one or more pre-configurations for the SRS antenna switching.

5. The apparatus of claim 4, wherein the at least one processor, at least in part with the memory, is further configured to:
transmit a UE capability indicating one or more SRS antenna switching configurations supported by the UE,
wherein the one or more pre-configurations for the SRS antenna switching are based on the UE capability.

6. The apparatus of claim 5, wherein the UE capability indicates one SRS antenna switching configuration supported by the UE, and the one or more pre-configurations for the SRS antenna switching are fallback or subset configurations of the one SRS antenna switching configuration.

7. The apparatus of claim 4, wherein the MAC-CE includes a bitmap, each bit in the bitmap representing the at least one suitable configuration as the subset of the one or more pre-configurations for the SRS antenna switching.

8. The apparatus of claim 4, wherein the MAC-CE includes a set of identifiers (IDs) representing the at least one suitable configuration identified from the one or more pre-configurations for the SRS antenna switching.

9. The apparatus of claim 3, wherein the MAC-CE includes one or more sets of bits, each set of bits including at least one bit representing a first number of transmit (Tx) antennae and at least one bit representing a second number of receive (Rx) antennae.

10. The apparatus of claim 1, wherein the indication of the at least one suitable configuration is transmitted via a radio resource control (RRC) message.

11. The apparatus of claim 1, wherein the at least one processor, at least in part with the memory, is further configured to:
compare the at least one suitable configuration with a previously identified configuration for the SRS antenna switching,
wherein the indication of the at least one suitable configuration is transmitted based on the at least one suitable configuration being different from the previously identified configuration for the SRS antenna switching.

12. The apparatus of claim 11, wherein the at least one processor, at least in part with the memory, is further configured to:
determine that a timer associated with the previously identified configuration for the SRS antenna switching expired,
wherein the indication of the at least one suitable configuration is transmitted further based on determining that the timer expired.

13. The apparatus of claim 1, wherein the at least one processor, at least in part with the memory, is further configured to:
compare the at least one suitable configuration with a current configuration for the SRS antenna switching,
wherein the indication of the at least one suitable configuration is transmitted based on the at least one suitable configuration being different from the current configuration for the SRS antenna switching.

14. The apparatus of claim 1, wherein the at least one processor, at least in part with the memory, is further configured to:
receive one or more pre-configurations for the SRS antenna switching; and
receive an instruction to reconfigure, activate, or deactivate at least a portion of the one or more pre-configurations for the SRS antenna switching,
wherein the at least one suitable configuration is identified as a subset of the one or more pre-configurations for the SRS antenna switching and the indication of the at least one suitable configuration is transmitted based on the received instruction.

15. The apparatus of claim 14, wherein the instruction to reconfigure, activate, or deactivate at least a portion of the one or more pre-configurations for the SRS antenna switching is received via RRC signaling or a MAC-CE.

16. The apparatus of claim 1, wherein the at least one processor, at least in part with the memory, is further configured to:
receive, from the base station, a request to transmit the at least one suitable configuration,
wherein the at least one suitable configuration is identified and the indication of the at least one suitable configuration is transmitted based on the request to transmit the at least one suitable configuration.

17. An apparatus for wireless communication at a base station, comprising:
a memory; and
at least one processor coupled to the memory, the at least one processor being configured to, at least in part with the memory:
receive, from a user equipment (UE), an indication of at least one suitable configuration for sounding reference signal (SRS) antenna switching;
select an active configuration for the SRS antenna switching based at least in part on the at least one suitable configuration for the SRS antenna switching; and
transmit, to the UE, an indication of the active configuration for the SRS antenna switching.

18. The apparatus of claim 17, further comprising a transceiver coupled to the at least one processor, wherein the at least one processor, at least in part with the memory, is further configured to:
transmit, to the UE, an indication of one or more SRS resources associated with the active configuration for the SRS antenna switching.

19. The apparatus of claim 17, wherein the indication of the at least one suitable configuration for the SRS antenna switching is received via a medium access control (MAC) control element (CE) (MAC-CE).

20. The apparatus of claim 19, wherein the at least one processor, at least in part with the memory, is further configured to:
transmit, to the UE, one or more pre-configurations for the SRS antenna switching, the at least one suitable configuration for the SRS antenna switching being a subset of the one or more pre-configurations for the SRS antenna switching.

21. The apparatus of claim 20, wherein the at least one processor, at least in part with the memory, is further configured to:
receive a UE capability indicating one or more SRS antenna switching configurations supported by the UE,
wherein the one or more pre-configurations for the SRS antenna switching are based on the UE capability.

22. The apparatus of claim 21, wherein the UE capability indicates one SRS antenna switching configuration supported by the UE, and the one or more pre-configurations for the SRS antenna switching are fallback or subset configurations of the one SRS antenna switching configuration.

23. The apparatus of claim 20, wherein the MAC-CE includes a bitmap, each bit in the bitmap representing the at least one suitable configuration as the subset of the one or more pre-configurations for the SRS antenna switching.

24. The apparatus of claim 20, wherein the MAC-CE includes a set of identifiers (IDs) representing the at least one suitable configuration as the subset of the one or more pre-configurations for the SRS antenna switching.

25. The apparatus of claim 19, wherein the MAC-CE includes one or more sets of bits, each set of bits including at least one bit representing a first number of transmit (Tx) antennae and at least one bit representing a second number of receive (Rx) antennae.

26. The apparatus of claim 17, wherein the indication of the at least one suitable configuration is received via a radio resource control (RRC) message.

27. The apparatus of claim 17, wherein the at least one processor, at least in part with the memory, is further configured to:
transmit, to the UE, one or more pre-configurations for the SRS antenna switching; and
transmit, to the UE, an instruction to reconfigure, activate, or deactivate at least a portion of the one or more pre-configurations for the SRS antenna switching,
wherein the at least one suitable configuration is a subset of the one or more pre-configurations for the SRS antenna switching and the indication of the at least one suitable configuration is received based on the transmitted instruction.

28. The apparatus of claim 17, wherein the at least one processor, at least in part with the memory, is further configured to:
transmit, to the UE, a request to transmit the at least one suitable configuration,
wherein the indication of the at least one suitable configuration is received based on the request to transmit the at least one suitable configuration.

29. A method of wireless communication at a user equipment (UE), comprising:
identifying at least one suitable configuration for sounding reference signal (SRS) antenna switching;
transmitting, to a base station, an indication of the at least one suitable configuration for the SRS antenna switching; and
receiving, from the base station, an indication of an active configuration for the SRS antenna switching based at least in part on the at least one suitable configuration.

30. A method of wireless communication at a base station, comprising:
receiving, from a user equipment (UE), an indication of at least one suitable configuration for sounding reference signal (SRS) antenna switching;
selecting an active configuration for the SRS antenna switching based at least in part on the at least one suitable configuration for the SRS antenna switching; and
transmitting, to the UE, an indication of the active configuration for the SRS antenna switching.
